(19) United States
(12) Patent Application Publication
(10) Pub. No.: US 2004/0019543 A1
(43) Pub. Date: Jan. 29, 2004

(54) Systems and methods for non-account based liability reporting

(75) Inventors: Lynn Holm Blagg, Omaha, NE (US); Paula Jane Vovk, Omaha, NE (US); Chris Christopherson, Yutan, NE (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO

(21) Appl. No.: 10/205,482

(22) Filed: Jul. 25, 2002

(51) Int. Cl. G06F 17/60

(52) U.S. Cl. 705/35

(57) ABSTRACT

The present invention provides systems and methods that provide liability and risk exposure information to a reporting entity, while limiting access to account level usage information. Such methods can include maintaining account information associated with a plurality of accounts. A reporting combination is formed from the plurality of accounts, and at least a portion of the information associated with the individual accounts is abstracted. The abstracted information is provided to a reporting entity such that the reporting entity is prevented from extracting account level information therefrom. Systems can include a computer with a communication device and a computer readable medium. The computer readable medium includes instructions executable by the computer to implement the aforementioned method.

### CROSS-REFERENCES TO RELATED APPLICATIONS

The present application is related to U.S. patent application Ser. No. 09/298,417, entitled “Methods For Processing a Group of Accounts Corresponding to Different Products”, filed on Apr. 23, 1999, sharing a common inventor with and assigned to the assignee of the present invention; U.S. patent application Ser. No. 09/298,505, entitled “Method For Linking Accounts Corresponding to Different Products”, filed on Apr. 23, 1999, sharing a common inventor with and assigned to the assignee of the present invention; U.S. patent application Ser. No. 09/298,521, entitled “Method For Defining a Relationship Between an Account and a Group”, filed on Apr. 23, 1999, sharing a common inventor with and assigned to the assignee of the present invention; and U.S. patent application No. ______ (Attorney Docket Number 20375-022400US), entitled “Systems And Methods For Accessing And Modifying Usage Parameters Associated With a Financial Transaction Account”, filed on Jun. 13, 2002, and also sharing a common inventor with and assigned to the assignee of the present invention. Each of the aforementioned patent applications in their entirety are incorporated herein by reference for all purposes.

### BACKGROUND OF THE INVENTION

The present invention relates generally to the field of financial reporting, and in particular to systems and methods for financial reporting that consolidates or otherwise abstracts underlying account details.

Financial products are used for conducting a wide range of consumer and business transactions. In a typical case, such products are issued to account holders by issuers including banks and credit card companies. The account holders utilize the products, and in doing so, incur liabilities for goods and services purchased. Such liabilities are typically reported to one or more credit reporting agencies in relation to the account with which the liabilities are associated. Thus, by obtaining a report from a credit reporting agency, it is possible to identify not only the liabilities incurred by a given account holder, but also the types of products issued to and utilized by the account holder.

Such detailed information allows competitors of issuers to identify potential customers for the competitor's products. Thus, by reporting distinct account information, an issuer is actually performing a valuable marketing function for the issuer's competitor. While this is undesirable, it is also unavoidable in the current state of the art where an issuer is compelled to report in order to obtain access to information from the credit reporting agencies. Thus, for at least this reason, there exists a need in the art for advanced systems and methods for reporting financial information.

### SUMMARY OF THE INVENTION

The present invention provides systems and methods for disclosing liability exposure and/or risk performance to a credit bureau, or other reporting entity. In addition to reporting information relevant to functions performed by a reporting entity, the systems and methods of the present invention can also limit access to account level usage information by the reporting entity and/or those accessing the reporting entity. In some embodiments of the present invention, the methods include providing full disclosure of liability exposure and risk performance information to a reporting entity, without providing marketing information and/or account usage details not germane to functions performed by the reporting entity. Thus, in some embodiments, the present invention provides an ability to provide information relevant to a reporting entity, thus taking advantage of benefits associated with reporting, without providing competitors with an unintended competitive advantage.

Such methods can include maintaining account information associated with a plurality of accounts. A reporting combination is formed from the plurality of accounts, and at least a portion of the information associated with the individual accounts is abstracted. The abstracted information is provided to a reporting entity such that the reporting entity is limited, restrained, or otherwise prevented from extracting account level information therefrom. Systems can include a computer with a communication device and a computer readable medium. The computer readable medium can include instructions executable by the computer to implement the aforementioned method.

In one particular embodiment of the present invention, a method for reporting non-account based financial information is provided. The method includes maintaining account information associated with two or more different accounts. A reporting combination is formed that includes both of the accounts, at least a portion of the information associated with the accounts is abstracted, and the abstracted information is provided to a reporting entity. By abstracting the information, the reporting entity and/or those accessing information from the reporting entity are limited or prevented from identifying one or more of the accounts from which the abstracted information was derived. Such a process can be implemented by a transaction processor, an issuer, or a combination of an issuer and a transaction processor. In some instances, forming the reporting combination includes identifying two or more accounts that are associated with a common account holder or owner.

In various instances, abstracting the information associated with the accounts includes combining information from accounts that are associated with a common owner. Such abstraction can include creating one or more statistics, such as, for example: a total delinquent amount associated with the first account and the second account, a total credit exposure associated with the first account and the second account, an aggregate of the credit limit for the first account and the second account, an aggregate of the balance outstanding on the first account and the second account, an aggregate of the balance outstanding on the first account and the second account as a percentage of an aggregate of the credit limit on the first account and the second account, an aggregate of the average daily balance for the first account and the second account, and an aggregate of the average daily balance for the first account and the second account as a percentage of an aggregate of the credit limit on the first account and the second account.

Yet further, the statistics can also include the longest period of delinquency on either the first account or the second account, the longest time to pay on a balance of either of the first account or the second account, most consecutive days delinquent on either the first account or the second account, a cumulative consecutive days delinquent between the first account and the second account, and an average of the number of days delinquent of the first account and the second account. Alternatively, or in addition, such abstraction can include a current address of the common owner, a social security number of the common owner, a last payment date, and/or a summary of payment history.

In some instances, one or more of the accounts is associated with an account group, and an owner of one of the accounts is also liable for one or more accounts within the account group. In such instances, abstraction can include providing statistics that incorporate information from one or more of the accounts within the account group.

Another embodiment of the present invention provides a system for reporting non-account based financial information. The system includes a computer associated with a communication device and a computer readable medium. The computer readable medium includes instructions executable by the computer to: receive and/or transaction information associated with two or more accounts, form reporting combinations from two or more accounts, abstract at least a portion of the information associated with the two or more accounts, and transfer the abstracted information to a reporting entity.

Yet another embodiment of the present invention provides a method for maintaining historical financial information. The method includes receiving information about an account holder, wherein the information about the account holder includes an abstract of information related to more than one account. Such abstract information can be received from either or both of a transaction processor and an issuer. The method further includes providing access to information that incorporates the abstract information to a requestor, wherein the requester is limited or prevented from identifying an individual account underlying the abstract information.

The summary provides only a general outline of the embodiments according to the present invention. Many other objects, features and advantages of the present invention will become more fully apparent from the following detailed description, the appended claims and the accompanying drawings.

### BRIEF DESCRIPTION OF THE DRAWINGS

A further understanding of the nature and advantages of the present invention may be realized by reference to the figures which are described in remaining portions of the specification. In the figures, like reference numerals are used throughout several figures to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 is a block diagram of a reporting system useful in relation to the present invention;

FIG. 2 is a block diagram of another reporting system useful in relation to the present invention;

FIG. 3 is a flow diagram of a reporting method in accordance with some embodiments of the present invention;

FIG. 4 is a flow diagram of another reporting method in accordance with other embodiments of the present invention;

FIG. 5 is a flow diagram for abstracting information in accordance with various embodiments of the present invention;

FIG. 6 is a block diagram of yet another reporting system in accordance with various embodiments of the present invention; and

FIG. 7 is a flow diagram illustrating a method in accordance with some embodiments of the present invention for reporting account group information.

### DETAILED DESCRIPTION OF THE INVENTION

Among other things, the present invention provides systems and methods for disclosing liability exposure and/or risk performance about two or more accounts and/or account components to a credit bureau, or other reporting entity. In addition to disclosing such information to a reporting entity, the systems and methods of the present invention can also limit access to account level usage information by the reporting entity and/or those accessing the reporting entity. In some embodiments of the present invention, the methods include providing full disclosure of liability exposure and risk performance information to a reporting entity, without providing marketing information and/or account usage details not germane to functions performed by the reporting entity. Thus, in some embodiments, the present invention provides an ability to provide information relevant to a reporting entity, thus taking advantage of benefits associated with reporting, without providing competitors with an unintended competitive advantage.

As used herein, a presentation instrument can be any instrument and/or information used by an account holder to effectuate a financial transaction. Thus, for example, a presentation instrument can be a credit card, a debit card, a smart card, an account number, a personal identification number, and/or any combination thereof. Such presentation instruments can be associated with a product offered by an issuer of the presentation instrument. Thus, for example, a presentation instrument may be associated with a MASTERCARD or VISA product. Alternatively, the presentation instrument may be associated with a credit card product and a stored value redemption card.

The financial industry has evolved from a situation where an account holder had one presentation instrument, and account associated therewith that was maintained by one financial institution. Today, an account holder may have several presentation instruments associated with one or more products, and maintained with one or more issuers. Thus, for example, an account holder may have a MASTERCARD, a VISA, and checking account provided by a common issuer. Based on this discussion, one of ordinary skill in the art will recognize a myriad of other combinations that an account holder may have. Further, a product may be associated with more than one underlying account and/or account holders. Thus, for example an account holder may possess a debit card that is associated with a checking account of the account holder and another checking account of another account holder. Various business rules may control the operation of the debit card including, for example, that transactions are first satisfied by the account holder's checking account, and then by the other account holder's checking account as a contingency. Again, based on the disclosure provided herein, one of ordinary skill in the art will recognize a number of other possible combinations.

From the previous discussion, it will be appreciated that as used herein an account holder can be any individual or entity having access to a presentation instrument, associated product, and/or account. Further, it will be appreciated that an issuer can be any entity that provides presentation instruments, financial products, and/or maintains accounts associated with such products and presentation instruments.

In part because of the myriad of products, presentation instruments, accounts, and combinations thereof that are possible, a number of marketing and cross-selling opportunities exist for issuers. For example, an issuer may cross-sell debit card services to account holders holding credit cards with the issuer. Additionally, an issuer may sell another credit card product to an account holder that enjoys one type of credit card product with the issuer.

Yet further, an issuer may cross-sell any number of products to family members and/or associates of an account holder that already enjoys a relationship with the issuer. Such an approach is particularly applicable when account holders are members of groups as described in U.S. patent application Ser. Nos. 09/298,417, 09/298,505, and 09/298,521, previously incorporated herein by reference for all purposes. In such situations, an account holder can utilize group relationships between two or more accounts and/or products. In some cases, the basis of such group relationships can be familial, contractual, or otherwise. In one case, an account holder procures multiple presentation instruments for use by dependent account holders within the group. Such account groups can share a transaction processing connection. For example, a credit line may be shared between various account holders within an account group. As another example, one account holder may be liable for activity on all accounts within the group, whether the activity is consummated by the account holder, or by other account holders within the group.

In some cases, issuers report activity related to account holders associated with the particular issuer to one or more reporting entities. As used herein, a reporting entity can include, but is not limited to credit bureaus, and other similar reporting bodies. As such reporting entities may limit the availability of information reported by other issuers, it is advantageous for an issuer to provide account holder information to reporting entities. Access to such information from a reporting entity generally makes it possible for an issuer to determine the level of secured, and unsecured debt for which an account holder is liable. Further, account delinquency information can be provided, and reporting entities may augment the information provided by issuers to include “scores” based on statistical analysis of the raw data provided by the various issuers in relation to an account holder. Such scores can represent statistical probabilities of certain conditions, such as the probability of delinquency by an account holder. These scores are useful to issuers in making determinations about whether to extend credit and/or offer certain products to a prospective account holder, and other such decisions.

Where individual account information is provided to a reporting entity by an issuer, it is possible for other issuers to determine the level and type of cross-selling that has been done in relation to a given account holder. Allowing access to such information is a significant disadvantage of reporting account and/or transaction information to reporting entities. As just one of many examples, access to such information can allow a competitor to identify customers (account holders) of a reporting issuer that have a good credit history and have been cross-sold other products by the reporting issuer. Such information provides valuable insight into the business practices of the reporting issuer, as well as identifying customers of the reporting issuer that are ripe for receiving product offers from competing issuers.

Thus, among the various other advantages provided, the present invention limits the level of information provided to reporting entities, while still satisfying an issuer's duty and/or desire to report information about account holders. Issuers are thus able to avail themselves of the advantages obtained through providing information to reporting entities, without divulging valuable marketing information and/or account specific information in a form useful to competitors. Other advantages are also captured within the scope of the claims, and will be apparent to one of ordinary skill in the art upon reading the disclosure provided herein.

In some embodiments of the present invention, reporting can be accomplished by aggregating data at a group level and/or by providing cross-account level reporting. Cross-account level reporting can include identifying all products associated with a liable account holder, and reporting an aggregate or summary of the information associated with the liable account holder. Thus, information reported about an account holder is not tied to any specific account. Indeed, such information can be garnered from any number of products and/or accounts associated with the account holder.

In account group situations, information about the actual liabilities of account holders within the group can be consolidated and reported in the consolidated form. Such can include reporting an aggregate of credit limits associated with the various liable account holders within a group, and reporting delinquency and account activity information attributed to account holders within the group. In some cases, an account holder may not be liable for all accounts within the group. As such, the abstraction rules used to combine information from across the various accounts consider liability issues in preparing information for disclosure to a reporting entity. Further, in account group situations, the liability may be shared, or may shift between different account holders within the group. Again, the abstraction rules can be tailored to account for this variable liability situation.

Non-account based liability reporting in accordance with some embodiments of the present invention allows reporting to occur with a cross-account or group identifier rather than an account number. In a cross-account situation where different liability among account holders can occur within the same account, the variation on liability can be reported with distinct records for each account holder associated with the cross-account reporting. As just one example, a customer identifier can be used to link various underlying accounts. Based on the disclosure herein one of ordinary skill in the art will recognize other such links.

In an account group situation, information about the actual liabilities of an account holder within the group can be reported to include both account level information and group level information. As an example, the account level information can include delinquency information associated with a particular account within the account group and/or any delay in payment on the particular account. Group level information can include, for example, an aggregation of credit limits of all accounts within the group for which the account holder shares some level of liability.

As another example, an account group can exist that includes a father sharing liability on accounts for his two minor children, which are also grouped with a grandparent for communication purposes. In such a case, reporting liability associated with the father includes aggregating liability for the father's account and the two child accounts. The grandparent's account,however, is not included as the father does not share liability for the account. Thus, the liability for the parent is reported using group level information. Alternatively, the grandparent is solely liable for the grandparent's account and thus the liability information is reported for the grandparent using account level information.

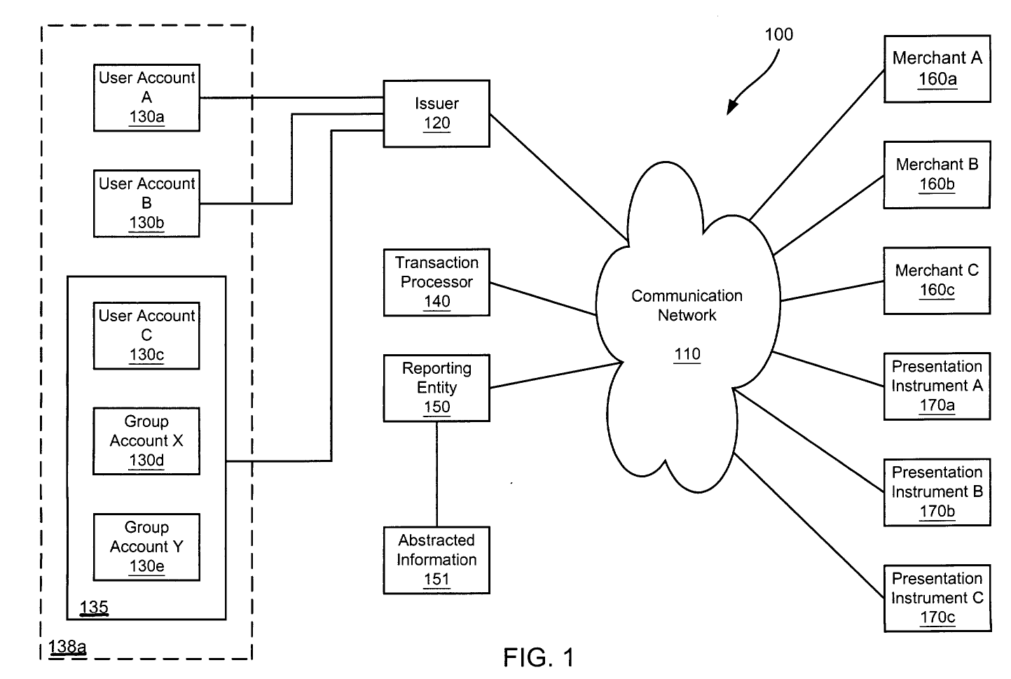

Referring to FIG. 1, a block diagram of a reporting system 100 useful in relation to the present invention is illustrated. Reporting system 100 includes a communication network 110 through which various entities involved in reporting system 100 can communicate. Such entities include one or more issuers 120, one or more transaction processors 140, one or more reporting entities 150, and one or more merchants 160. Further, one or more presentation instruments 170 can be used in relation to reporting system 100. Such presentation instruments can be presented to a merchant 160 directly, or via communication network 110 as illustrated.

Various accounts 130 are maintained by issuer 120 and associated with one or more presentation instruments 170. In one instance, user account 130a is a credit card account and presentation instrument 170a is a credit card associated with account 130a. Similarly, user account 130b can be a checking account, and presentation instruments 170b, 170c can both be associated with account 130b. Based on the disclosure provided herein, one of ordinary skill in the art will of course recognize a variety of other account types and/or presentation instruments that can be used in relation to the present invention.

User accounts 130c, 130d, and 130e are combined in an account group 135. As previously mentioned, such account groups can involve one or more account holders sharing liability and/or other account characteristics between a plurality of accounts and/or products. Further, accounts 130c, 130d, 130e can be owned by one or more account holders and associated with one or more products.

All of the illustrated user accounts 130 are combined in a reporting combination 138. As discussed below in greater detail, such reporting combinations can be utilized as the basis for abstracting information associated with one or more account holders prior to providing the information to reporting entity 150. The information provided to reporting entity 150 can be maintained as abstracted information 151. Information related to accounts 130 can be gathered and/or maintained by either or both of issuer 120 and transaction processor 140. For the purposes of this document, a transaction processor is an entity that processes transactions occurring in relation to accounts maintained by issuer 120. Such processing can include receipt of transaction and/or account information associated with the accounts, abstracting the information, and reporting the abstracted information to either or both of reporting entity 150 and issuer 120.

Thus, in some embodiments of the present invention, transaction and/or account information can be received, abstracted, and reported to reporting entity 150 by issuer 120. In other embodiments, transaction and/or account information can be received by issuer 120, provided to transaction processor 140 via communication network 110, abstracted and provided to reporting entity 150 by transaction processor 140. In yet other embodiments, transaction and/or account information can be received, abstracted and provided to reporting entity 150 by transaction processor 140. Based on the disclosure provided herein, one of ordinary skill in the art will recognize other possible combinations for receiving, abstracting, and providing the transaction and/or account information that can be used within the scope of the appended claims.

Communication network 110 can be any communication network capable of providing communications between the various entities of reporting system 100. In some embodiments, communication network 110 is the Internet providing message based communication between any of issuer 120, transaction processor 140, reporting entity 150, merchant 160, and/or an account holder using presentation instrument 170. In other embodiments, communication network 110 comprises a TCP/IP compliant virtual private network (VPN). In yet other embodiments, communication network 110 includes the Internet for communication between merchant 160 and issuer 120 or transaction processor 140, a VPN between issuer 120 and transaction processor 140, another VPN between reporting entity 150 and issuer 120 or transaction processor 140, and a telephone network between an account holder presenting presentation instrument 170 to merchant 160. However, it should be recognized that other communication networks could be used to provide similar functionality. For example, communication network 110 can be a local area network (LAN), a wide area network (WAN), a telephone network, a cellular telephone network, a virtual private network (VPN), the Internet, an optical network, a wireless network, or any other similar communication network or combination thereof.

As a simple example illustrating the use of reporting system 100, an account holder provides presentation instrument 170a to merchant 160a to purchase a good or service. Via communication network 110, merchant 160a requests authorization from transaction processor 140 to charge the purchase price against account 130a that is associated with presentation instrument 170a. Transaction processor 140 maintains a record of the transaction associated with account 130a. Transaction processor 140 can further send a bill to an account holder associated with account 130a, and in turn maintain a record of payments received and other statistics associated with account 130a. Thus, transaction processor 150 maintains a record of a variety of transaction and/or account information associated with account 130a. Such transaction information can include debits, credits, interest accrued, delays in payment, delinquency, and other such information associated with account 130a.

Periodically, transaction processor 140 can abstract the information associated with account 130a, along with information from other accounts associated with the account holder. Thus, for example, where the account holder is liable for accounts 130a, 130b, and accounts 130c, 130d of account group 135, account information associated with accounts 130a, 130b, 130c and 130d is used to create abstract information 151. Further, because the account holder is associated with account group 135, a portion of the account group information can also form part of abstract information 151, depending upon one or more abstraction rules as further discussed below. This abstracted information can then be provided to reporting entity 150 via communication network 110 where it is maintained as abstracted information 151. At this point, the abstracted information is then accessible by one or more requesters (not shown) accessing reporting entity 150.

In some cases, issuer 120 performs one or more of the functions of transaction processor 140. Thus in some cases, the aforementioned process involves communication between transaction processor 140 and issuer 120 via communication network 110. In other cases where issuer 120 performs all of the aforementioned functions, transaction processor 140 is not needed and can be eliminated from reporting system 100.

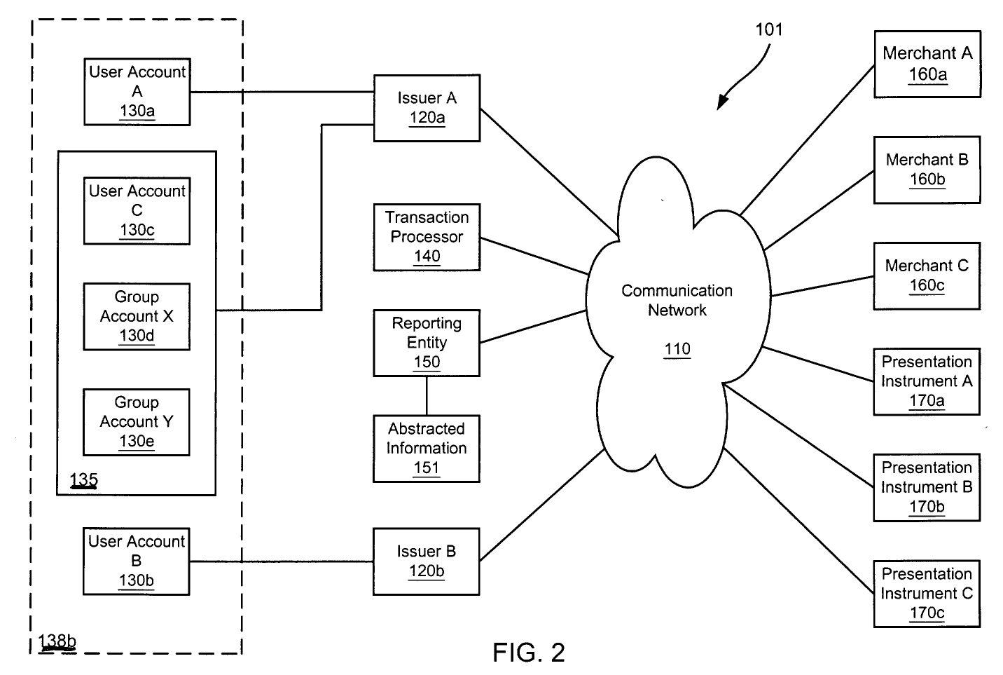

Referring to FIG. 2, a block diagram of another reporting system 101 useful in relation to the present invention is illustrated. Reporting system 101 is similar to reporting system 100 described above. However, in reporting system 101, transaction processor 140 provides an additional service of abstracting transaction and/or information associated with accounts maintained by two distinct issuers 120a, 120b. More particularly, reporting combination 138 includes the same accounts 130 as illustrated in relation to reporting system 100, but account 130b is maintained by issuer 120b and the other accounts 130a, and account group 135 along with its associated accounts 130c, 130d, 130e are maintained by issuer 120a.

Using the approach illustrated in relation to reporting system 101, transaction processor 140 can receive transaction and/or account information associated with all of the illustrated accounts 130, abstract information associated with an account holder associated with the accounts, and provide the abstracted information to reporting entity 150. The transaction and/or account information associated with the accounts can be received by transaction processor 140 directly from merchants 160, and account holders, indirectly from issuers 120 associated with the respective accounts 130, or a combination of both indirect and direct reception. Such an approach can be advantageous where multiple issuers 120 contract with transaction processor 140 to process transactions and provide abstracted information to reporting entity 150. In this way, a reporting entity 150, as well as requesters requesting information from reporting entity 150, are prevented from obtaining account level information for account holders maintaining only a single account 130 with an issuer 120. Thus, such embodiments are particularly applicable to groups of issuers 120 that process transactions via a common transaction processor 140.

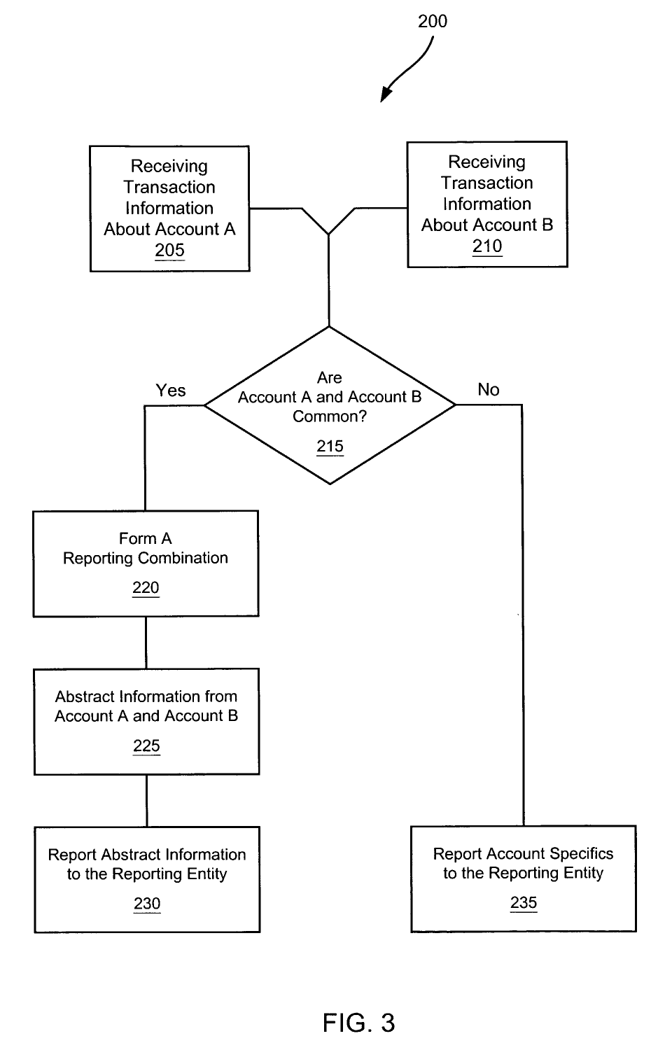

Referring now to FIG. 3, a flow diagram 200 illustrates a method in accordance with some embodiments of the present invention for non-account based liability reporting. As will be apparent from flow diagram 200, the method illustrated can be implemented by either transaction processor 140, issuer 120, or a combination of issuer 120 and transaction processor 140. Following flow diagram 200, transaction and/or account information is received about account 130a (block 205), and about account 130b (block 210). Such transaction and/or account information can include, but is not limited to, purchases made via merchant 160 that are applied against accounts 130, payments received from the account owner(s) or third parties, delinquency status of accounts 130, modification of usage parameters associated with accounts 130 such as credit limits, and the like. This transaction and/or account information is stored in a computer readable medium associated with a computer maintained by either or both of issuer 120 and transaction processor 140.

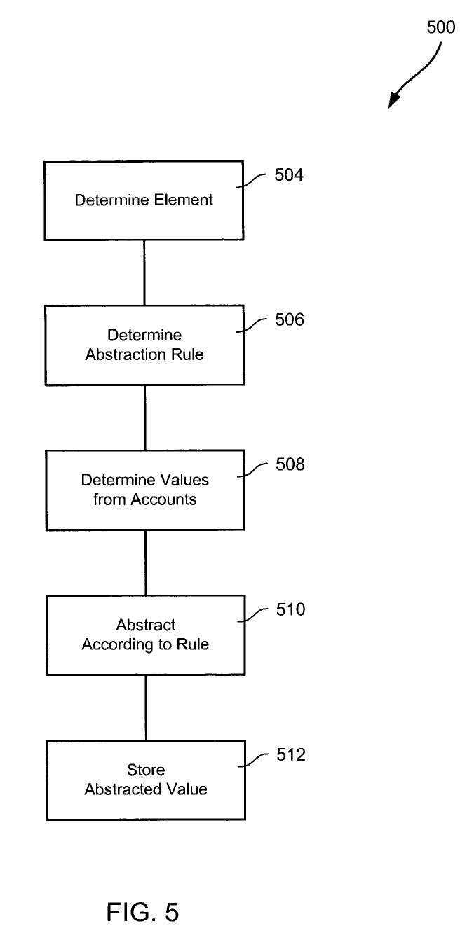

Either periodically or continuously as the transaction and/or account information is received, the computer readable medium is queried and the transaction and/or account information is abstracted. In the embodiment illustrated as flow diagram 200, the process includes identifying accounts 130 that share a particular common tie (block 215). The identified accounts are related together in a reporting combination 138 (block 220). Reporting combinations 138 can be identified by including a reporting combination identifier along with each account included with the reporting combination 138. Thus, it is not necessary for subsequent processing to reform reporting combinations, but rather only use the identifier to properly associate the various accounts and transaction information associated therewith. In some embodiments, all accounts 130 for which a common account holder is liable are related in reporting combination 138. Information associated with the accounts related together in reporting combination 138 is then abstracted to create information that will be reported to reporting entity 150 (block 225). The process of abstraction is discussed in greater detail with reference to FIG. 5 below. The abstracted information is then provided to reporting entity 150 in accordance with reporting norms established between issuer 120 or transaction processor 140, and reporting entity 150 (block 225).

Alternatively, where it is determined that an account 130 is not common to another account or account group, a reporting combination 138 is not formed (block 215). Where a reporting combination 138 is not formed, account level information associated with an ungrouped account 130 can be provided to reporting entity 150 (block 235).

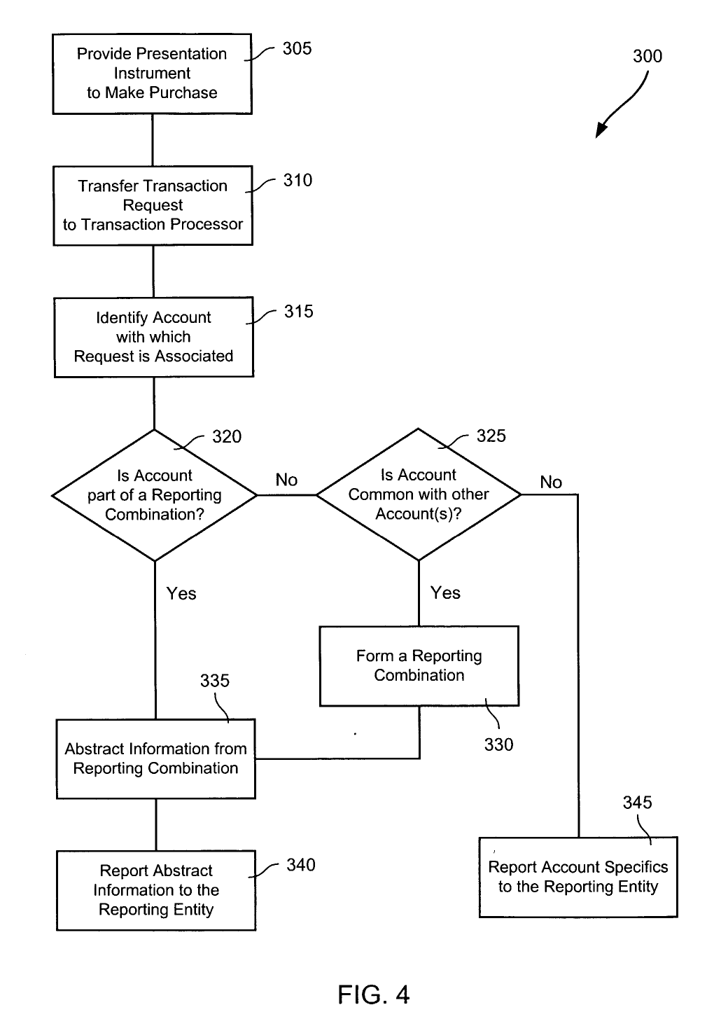

Referring now to FIG. 4, a flow diagram 300 illustrates a method in accordance with other embodiments of the present invention for non-account based liability reporting. Again, the method illustrated by flow diagram 300 can be implemented by either transaction processor 140, issuer 120, or a combination of issuer 120 and transaction processor 140. Following flow diagram 300, an account holder or other party provides a presentation instrument 170 to a merchant 160 to make a purchase (block 305). The transaction request is sent to the processing entity, which in this case is transaction processor 140 (block 310). Transaction processor 140 identifies account 130 to which presentation instrument 170 is associated (block 315). Transaction processor 140 authorizes the transaction and records the information on a computer readable medium associated with a computer that is maintained by transaction processor 140.

Either periodically or continuously as the transaction and/or account information is received, the computer readable medium is queried by transaction processor 140. As part of the query, it is determined if account 130 to which the received transaction information is associated is part of a reporting combination 138 (block 320). In some embodiments, this is manifest by a reporting combination identifier associated with account 130. Where such an identifier is blank or null, it is presumed that account 130 has not previously been related to a reporting combination 138. Alternatively, where a non-null identifier is associated with account 130, the transaction and/or account information associated with account 130, as well as transaction information associated with other accounts included in reporting combination 138, is abstracted (block 335). The abstracted information is then provided to reporting entity 150 (block 340).

Where account 130 for which the transaction information is received is not already part of a reporting combination 138 (block 320), transaction information on the computer readable medium is queried by transaction processor 140 to determine if account 130 is common with any other accounts (block 325). Again, in some embodiments, this can include determining if an account holder associated with account 130 shares liability for another account, and/or account group. Where such commonality is found between accounts and/or account groups, a reporting combination 138 is formed to include account 130 with the other common accounts (block 330). In some cases, this can include grouping account 130 with a previously formed reporting combination 138. In other cases, it can include grouping account 130 with another account, and/or account group that was not previously associated with a reporting combination 138. With account 130 associated with a reporting combination 138, the transaction information can be abstracted (block 335), and the abstracted information provided to reporting entity 150 (block 340).

Alternatively, where it is determined that an account 130 is not common to another account or account group, a reporting combination 138 is not formed (block 325). Where a reporting combination 138 is not formed, account level transaction information associated with an ungrouped account 130 can be provided to reporting entity 150 (block 345).

Referring to FIG. 5, a flow diagram 500 illustrates a method for abstracting transaction and/or account information in accordance with an embodiment of the present invention. Such an abstraction process can be performed by transaction processor 140, issuer 120, or other suitable entity. Following flow diagram 500, the various element types associated with transaction and/or account information of the various accounts 130 in a reporting combination 138 are determined (block 504). Such element types for an account 130 and/or an account group 135 can include, but are not limited to, an outstanding balance, a credit limit, delinquency status, maximum time before a payment was received, average time before a payment was received, an average daily balance on the account, longest period of delinquency, address of the account holder, and social security number for the account holder. Based on this disclosure, one of ordinary skill in the art will recognize other element types associated with accounts 130 and/or account groups 135.

In addition, abstraction rules applicable to the various element types represented by reporting combination 138 are determined (block 504). As one example, where the element type is outstanding balance, an abstraction rule that calls for aggregating the outstanding balance of all accounts 130 and/or account groups 135 in reporting combination 138 may be selected. As another example, where the element type is a credit limit an abstraction rule that calls for aggregating the credit limits of all accounts 130 and/or account groups 135 in reporting combination 138 may be selected. A more complex abstraction rule may also be selected that combines multiple types. For example, an abstraction rule may be selected that aggregates the outstanding balance across relevant accounts as a percentage of the total credit line available across the same accounts.

Other abstraction rules can include, but are not limited to, rules that provide: an aggregate of the credit limit for all accounts in reporting combination 138, average time to pay across all accounts in reporting combination 138, an aggregate of the average daily balance for all accounts in reporting combination 138, an aggregate of the average daily balance as a percentage of an aggregate of the credit limit of all accounts in reporting combination 138, the longest period of delinquency on any account in reporting combination 138, the longest delay in payment on any account in reporting combination 138, all addresses reported for an account holder, a social security number of the account holder. Further, based on the discussion provided herein, one of ordinary skill in the art will recognize other abstraction rules that may be employed within the scope of the claims provided herein.

With the abstraction rules determined (block 506), values from the various accounts 130 and/or account groups 135 that are associated with elements to which the abstraction rules will be applied are obtained through access to the computer readable medium (block 508). Thus, for example, where the abstraction rule provides for aggregating the outstanding balances of the various accounts 130, the outstanding value of the various accounts is obtained. The abstraction rules are then applied to the accessed values (block 510) and the result of applying the abstraction rule is stored to the computer readable medium (block 512). In some embodiments, such results can be maintained with a pointer and/or designator associating the abstracted information with reporting combination 138. Thus, in the embodiments, providing the abstracted information to reporting entity 150 includes accessing all information indicated by the pointer and/or designator, and transferring the information to reporting entity 150.

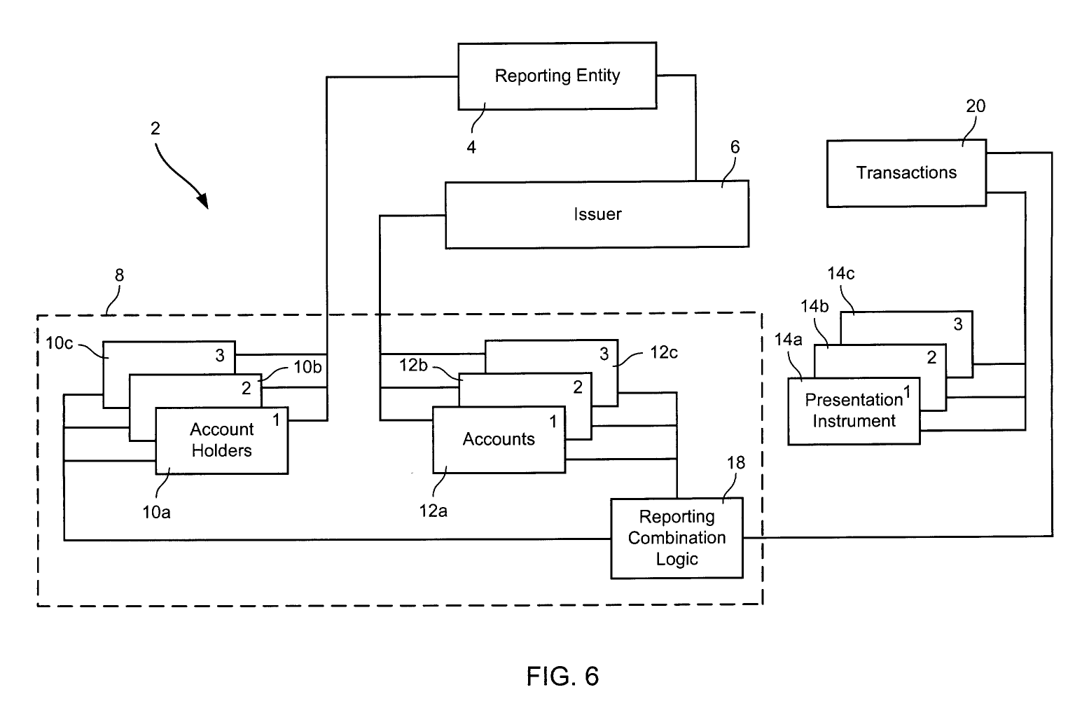

Referring to FIG. 6, a block diagram of a reporting system 2 where a transaction processor 8 receives transaction information 20 that can be generated in relation to one or more presentation instruments 14. Transaction processor 8 maintains account level information 12 separate from account holder information 10. In accordance with the present invention, account holder information 10 is reported on a non-account basis to a reporting entity 4, and account level information 12 is reported to an issuer 8. Transaction processor 8 includes reporting combination logic 18 for identifying account holder information 10, and abstracting such information prior to updating reporting entity 150.

In some embodiments, reporting combination logic 18 includes a computer with a communication device and a computer readable medium. The communication device can be any device allowing the computer to receive and/or request transaction information 20. In some cases, transaction information 20 is received via a merchant (not shown), or other transaction point. Thus, the communication device can be a card level modem or other means for communicating with a source of transaction information. Indeed, the communication device can be any type of device capable of receiving and transferring communication via the various networks previously discussed in relation to communication network 110. The computer readable medium can be any memory type device capable of maintaining information and/or computer instructions in relation to reporting combination logic 1 8. Thus, for example, computer readable medium can be a database either implemented as a stand alone database, or integrated with reporting combination logic 18. Further, the computer readable medium may comprise a random access memory, a hard disc drive, a floppy disc, a CD ROM, or other similar memory device or combination thereof.

The aforementioned methods, along with other similar methods can be used in relation to reporting system 2. As illustrated, transaction information 20 is received by reporting combination logic 18. Reporting combination logic 18 stores transaction information 20 with an account 12 to which the transaction information is related. In addition, reporting combination logic 18 identifies any reporting combination 138 to which transaction information 20 is related. As provided in the illustrated embodiment, such reporting combinations 138 are based on common account holders and therefor maintained as account holder information 10. It should be recognized that other commonality may provide the basis of reporting combinations 138 including, for example, an address to which statements associated with an account are sent.

In addition, reporting combination logic 18 identifies account holder information 10 to which transaction information 20 pertains (or forms a new reporting combination as discussed in relation to FIGS. 3-4). Having identified the related account holder information 10, the elements of account holder information 10 are accessed and transaction information 20 incorporated therewith as previously discussed in relation to FIG. 5. Using such an approach, account holder information 10 and account information 12 remain segregated and are prepared for updating to issuer 6 and/or reporting entity 4.

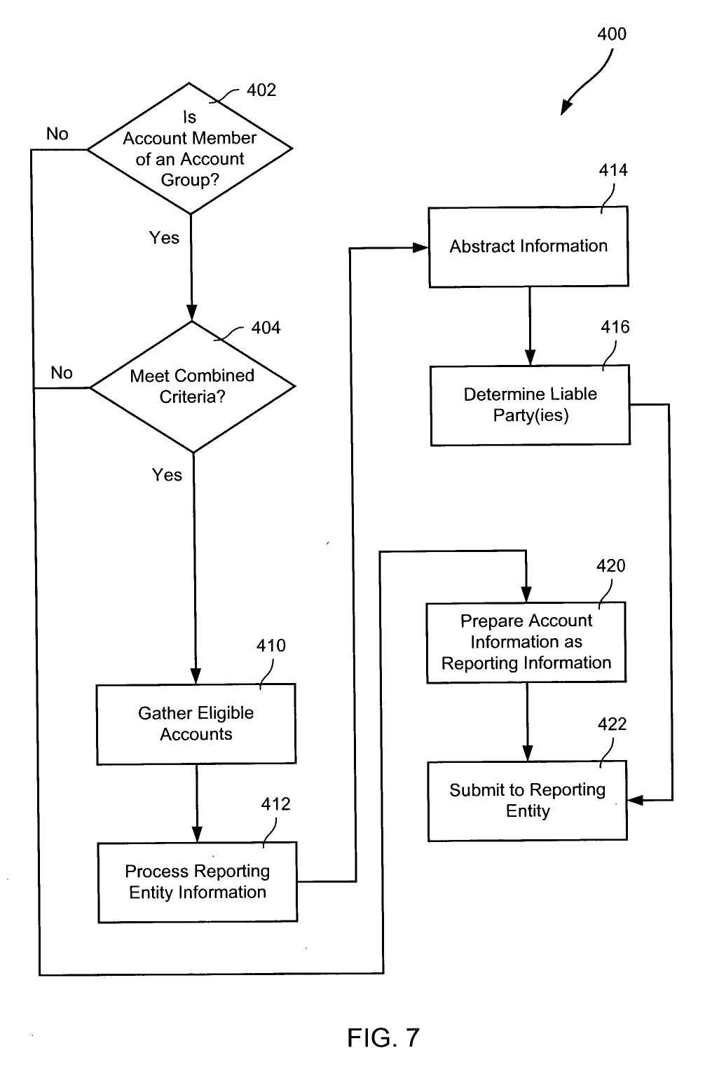

Referring to FIG. 7, a flow diagram 400 illustrates a method in accordance with yet other embodiments of the present invention. In particular flow diagram 400 illustrates a method that considers whether an account is a member of an account group 135, and if that membership effects the reporting process. As will be appreciated, flow diagram 400 does not consider whether an account should be combined with other individual accounts, or other reporting combinations 138 as both of these concepts were discussed in relation to FIGS. 3 and 4 above. Thus, one ordinary skill in the art will appreciate that the concepts discussed in relation to flow diagram 400 can be incorporated with those discussed in relation to FIGS. 3 and 4 Such that both membership within a group, as well as commonality between individual accounts and/or account groups can be considered.

Following flow diagram 400, transaction information is received and from the transaction information, an account associated therewith is identified. It is then determined if the account is a member of an account group (block 402). Where the account is not a member of an account group, information about the individual account is stored as information to be reported (block 420), and subsequently reported to reporting entity 150 (block 422).

Alternatively, where it is determined that the account is a member of an account group (block 402), it is next determined if other accounts within the account group meet reporting criteria such that information from the other accounts should be combined with the account (block 404). Thus, for example, where the reporting criteria include abstracting information from all accounts where a common account holder is liable, then all account within the account group for which the account holder of the identified account is liable are included. If information from other accounts within the account group are not to be reported, information about the individual account is stored as information to be reported (block 420), and subsequently reported to reporting entity 150 (block 422).

Where, on the other hand, other accounts within the account group are to be included (block 404), the eligible accounts are identified (block 410) and elements of the accounts that are relevant to reporting entity 150 are accessed (block 412). The information from the various accounts is then abstracted as previously described (block 414), and associated with the account holder that is liable for the accounts (block 416). The abstracted information is then submitted to reporting entity 150 in relation to the liable account holder (block 422).

The invention has now been described in detail for purposes of clarity and understanding. However, it will be appreciated that certain changes and modifications may be practiced within the scope of the appended claims. For example, an account holder may have a MASTERCARD provided by one issuer, and a VISA and checking account provided by another issuer that are combined for reporting purposes. Accordingly, it should be recognized that many other systems, functions, methods, and combinations thereof are possible in accordance with the present invention. Thus, although the invention is described with reference to specific embodiments and figures thereof, the embodiments and figures are merely illustrative, and not limiting of the invention. Rather, the scope of the invention is to be determined solely by the appended claims.

What is claimed is:

1. A method for reporting non-account based financial information, the method comprising:
maintaining account information associated with a first account;
maintaining account information associated with a second account;
forming a reporting combination including the first account and the second account;
abstracting at least a portion of the information associated with the first account and the information associated with the second account; and
reporting the abstracted information to a reporting entity, wherein the reporting entity is limited from identifying the first account.

2. The method of claim 1, wherein the account information associated with the first account and the account information associated with the second account is maintained by a transaction processor.

3. The method of claim 2, wherein the transaction processor is in communication with the reporting entity via a communication network.

4. The method of claim 2, the method further comprising:
maintaining account information associated with a third account, wherein the reporting combination further includes the third account, and wherein the abstracting further includes abstracting at least a portion of the information associated with the third account.

5. The method of claim 1, wherein the account information associated with the first account and the account information associated with the second account is maintained by an issuer.

6. The method of claim 1, wherein forming the reporting combination includes identifying two or more accounts that are associated with a common owner.

7. The method of claim 6, wherein the abstracting at least a portion of the information associated with the first account and the information associated with the second account includes combining account information from the first account associated with the common owner with account information from the second account associated with the common owner.

8. The method of claim 1, wherein the abstracting includes creating one or more statistics selected from a group consisting of a total delinquent amount associated with the first account and the second account, a total credit exposure associated with the first account and the second account, an aggregate of the credit limit for the first account and the second account, an aggregate of the balance outstanding on the first account and the second account, an aggregate of the balance outstanding on the first account and the second account as a percentage of an aggregate of the credit limit on the first account and the second account, an aggregate of the average daily balance for the first account and the second account, and an aggregate of the average daily balance for the first account and the second account as a percentage of an aggregate of the credit limit on the first account and the second account.

9. The method of claim 8, wherein the abstracting further includes providing one or more statistics selected from a group consisting of: the longest period of delinquency on either the first account or the second account, the longest time to pay on a balance of either of the first account or the second account, most consecutive days delinquent on either the first account or the second account, a cumulative consecutive days delinquent between the first account and the second account, and an average of the number of days delinquent of the first account and the second account.

10. The method of claim 8, wherein the abstracting comprises combining information from the first account associated with a common owner with information from the second account associated with the common owner, and wherein the abstracting further includes providing one or more statistics selected from a group consisting of: a current address of the common owner, a social security number of the common owner, a last payment date, a summary of payment history.

11. The method of claim 1, wherein the first account is associated with an account group.

12. The method of claim 11, wherein an owner of the second account is also liable for the account group.

13. The method of claim 12, wherein the abstracting includes creating one or more statistics selected from a group consisting of: a total delinquent amount associated with the second account and all accounts in the account group for which the owner is liable, a total credit exposure associated with the second account and all accounts in the account group for which the owner is liable, an aggregate of the credit limit for the second account and all accounts in the account group for which the owner is liable, an aggregate of the balance outstanding on the second account and all accounts in the account group for which the owner is liable, an aggregate of the balance outstanding on the second account and all accounts in the account group for which the owner is liable as a percentage of an aggregate of the credit limit on the second account and all accounts in the account group for which the owner is liable, an aggregate of the average daily balance for the second account and all accounts in the account group for which the owner is liable, and an aggregate of the average daily balance for the second account and all accounts in the account group for which the owner is liable as a percentage of an aggregate of the credit limit on the second account and all accounts in the account group for which the owner is liable.

14. A system for reporting non-account based financial information, the system comprising:
a computer, wherein the computer comprises a communication device and a computer readable medium, and wherein the computer readable medium comprises instructions executable by the computer to:
receive account information associated with a first account, and account information associated with a second account;
form a reporting combination including the first account and the second account;
abstract at least a portion of the information associated with the first account and the information associated with the second account; and
transfer the abstracted information to a reporting entity, wherein the reporting entity is limited from extracting the information associated with the first account.

15. The system of claim 14, wherein forming the reporting combination includes identifying two or more accounts that are associated with a common owner, and wherein the abstracting at least a portion of the information associated with the first account and the information associated with the second account includes combining information from the first account associated with the common owner with information from the second account associated with the common owner to create one or more statistics selected from a group consisting of: a total delinquent amount associated with the first account and the second account, a total credit exposure associated with the first account and the second account, an aggregate of the credit limit for the first account and the second account, an aggregate of the balance outstanding on the first account and the second account, an aggregate of the balance outstanding on the first account and the second account as a percentage of an aggregate of the credit limit on the first account and the second account, an aggregate of the average daily balance for the first account and the second account, and an aggregate of the average daily balance for the first account and the second account as a percentage of an aggregate of the credit limit on the first account and the second account.

16. A method for maintaining historical financial information, the method comprising:
receiving information about an account holder, wherein the information about the account holder includes an abstract of information related to a first account and information related to a second account, and wherein the abstract is received from one of a group consisting of: a transaction processor and an issuer; and
providing access to information that incorporates the abstract to a requester, wherein the requester is prevented from identifying the first account.

17. The method of claim 16, wherein the abstract is received via a communication network.

18. The method of claim 16, wherein the first account is associated with an account group, and wherein the owner of the first account is liable for one or more other accounts associated with the account group.

19. The method of claim 18, wherein the abstract includes information related to the one or more other accounts associated with the account group.

20. The method of claim 19, wherein the requestor is prevented from identifying the account group.

21. A method for reporting liability information, the method comprising:
maintaining account information associated with a first account, wherein the first account is associated with a first issuer;
maintaining account information associated with a second account, wherein the second account is associated with a second issuer;
forming a reporting combination including the first account and the second account;
abstracting at least a portion of the information associated with the first account and the information associated with the second account; and
reporting the abstracted information to a reporting entity, wherein the reporting entity is limited from extracting the information associated with the first account.
